(19) United States
(12) Patent Application Publication
(10) Pub. No.: US 2016/0013523 A1
(43) Pub. Date: Jan. 14, 2016

(54) Apparatus For Electrochemical Cell Temperature Measurement In A Battery Pack

(71) Applicants: Robert Bosch Battery Systems LLC, Orion, MI (US); Robert Bosch GmbH, Stuttgart (DE)

(72) Inventor: Joshua Anzicek, Clarkston, MI (US)

(21) Appl. No.: 14/751,377

(22) Filed: Jun. 26, 2015

Related U.S. Application Data
(60) Provisional application No. 62/021,979, filed on Jul. 8, 2014.

(51) Int. Cl. H01M 10/48

(52) U.S. Cl. CPC H01M 10/486

(57) ABSTRACT

A temperature monitoring apparatus for a battery that includes at least one electrochemical cell has been developed. The temperature monitoring apparatus includes a printed circuit board mounted to a battery pack. The printed circuit board supports at least one infrared sensor that is positioned to view infrared radiation that is emitted from the surface of the at least one electrochemical cell in the battery pack without contacting a surface of the at least one electrochemical cell. A controller is operatively connected to the at least one infrared sensor to identify a temperature of the at least one electrochemical cell with reference to a temperature signal that is generated by the at least one infrared sensor.

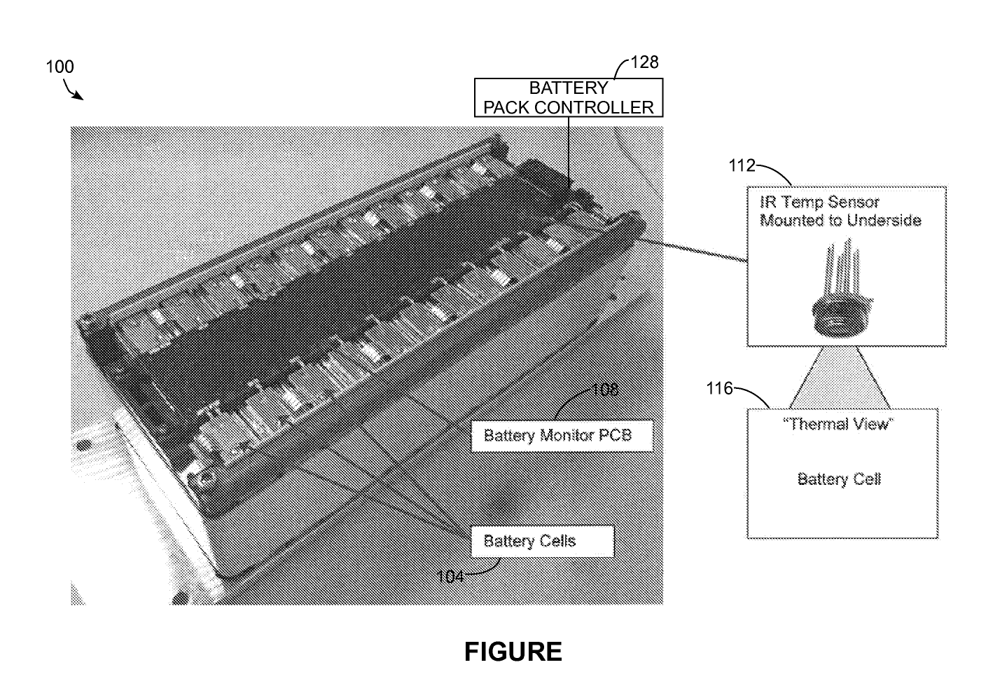

### CLAIM OF PRIORITY

This application claims prior to U.S. Provisional Application No. 62/021,979, which is entitled “Apparatus For Electrochemical Cell Temperature Measurement In A Battery Pack,” and was filed on Jul. 8, 2014, the entire contents of which are hereby incorporated by reference herein.

### FIELD

This disclosure relates generally to the field of batteries and, more specifically, to apparatuses for temperature measurement in battery packs.

### BACKGROUND

Battery systems often include temperature sensors that monitor the operating temperatures of one or more electrochemical cells during operation of the battery. Monitoring the temperature of individual cells in a battery pack enables a battery pack controller to draw power from the battery pack efficiently, prevent overheating of the battery pack, and identify individual electrochemical cells that should be replaced or bypassed to maintain operation of the battery pack at peak efficiency.

Many battery packs include contact-based thermal sensors such as thermocouples, thermistors, and other contact-based temperature sensors. To operate effectively, each contact-based thermal sensor needs to be affixed to the surface of a cell or other structure in the battery pack to monitor the temperature in the cell or structure. Affixing the contact-based temperature sensors increases the complexity of producing the battery pack and care must be taken to secure the temperatures sensors so that the temperature sensors remain in position during operation of the battery in the presence of vibration or other forces that could separate the temperature sensors from the corresponding structures in the battery pack. Consequently, improvements to temperature sensing apparatuses in battery packs that reduce or eliminate the need for contact-based temperature sensors would be beneficial.

### SUMMARY

A temperature monitoring apparatus for a battery that includes at least one electrochemical cell has been developed. The temperature monitoring apparatus includes a printed circuit board mounted to a battery pack. The printed circuit board supports at least one infrared sensor that is positioned to view infrared radiation that is emitted from the surface of the at least one electrochemical cell in the battery pack without contacting a surface of the at least one electrochemical cell. A controller is operatively connected to the at least one infrared sensor to identify a temperature of the at least one electrochemical cell with reference to a temperature signal that is generated by the at least one infrared sensor.

### BRIEF DESCRIPTION OF THE DRAWINGS

The FIGURE depicts a battery pack with a printed circuit board (PCB) that holds infrared temperature sensors that measure the surface temperatures of electrochemical cells in the battery pack in a non-contact manner.

### DETAILED DESCRIPTION

For the purposes of promoting an understanding of the principles of the embodiments disclosed herein, reference is now be made to the drawings and descriptions in the following written specification. No limitation to the scope of the subject matter is intended by the references. The present disclosure also includes any alterations and modifications to the illustrated embodiments and includes further applications of the principles of the disclosed embodiments as would normally occur to one skilled in the art to which this disclosure pertains.

The FIGURE depicts an illustrative configuration of a battery pack 100 that incorporates non-contact infrared temperature sensors to sense the temperature of at least one electrochemical cell in the battery pack 100. The battery pack 100 include an array of electrochemical battery cells 104 and a printed circuit board (PCB) 108 that is attached to the battery pack 100 in a “look down” configuration that provides a direct line of site to the battery cells 104. Each of the battery cells 104 is an electrochemical cell, and the battery pack 100 includes one or more of the battery cells 104. The PCB 108 supports an array of infrared (IR) temperature sensors 112 that are mounted to the underside of the PCB 108. The PCB 108 and temperature sensors 112 are located at a predetermined distance from the surfaces of the corresponding battery cells 104. In the illustrative example of the battery pack 100, each of the infrared sensors 112 is positioned to view a portion of the surface of one of the battery cells 104 to monitor levels of infrared emissions from the corresponding battery cell 104 during operation of the battery pack 100. One example of a suitable infrared sensor is the Melexis MLX90247, which is sold by the Melexis Corporation of Ypres, Belgium. As depicted in the FIGURE, each of the IR temperature sensors 112 is positioned on the PCB 108 with a “thermal view” 116 of the surface of a corresponding electrochemical cell in the array of battery cells 104.

In the battery pack 100, a battery pack controller 128 is operationally connected to the IR temperature sensors 112 through the PCB 108. In one embodiment, the battery pack controller 128 includes an application specific integrated circuit (ASIC) such as the Freescale MC33771 battery monitoring ASIC, which is sold by Freescale Semiconductor, Inc. of Austin, Tex. Alternative embodiments of the battery pack controller 128 incorporate microprocessors, microcontrollers, field programmable gate arrays (FPGAs), and other suitable digital logic devices. The battery pack controller 128 is operatively connected to one or more infrared sensors using, for example, an analog to digital converter that generates a digital representation of analog output signals from the infrared sensor and two or more general-purpose input-output (GPIO) connectors in the battery pack controller 128. The battery pack controller 128 identifies the surface temperatures of the electrochemical battery cells 104 with reference to the digital temperature sensor data from the infrared sensors 112. In one configuration, the controller 128 identifies the temperature of each electrochemical battery cell 104 in the battery pack using a corresponding one of the IR temperature sensors 112. While not shown expressly in the FIGURE, during operation the battery pack 100 is connected to one or both of a charging source, such as a lithium-ion battery charger or other suitable charging device, and a load, such as an electric motor or any other device that receives electric power from the battery pack 100.

During operation, the battery controller 128 optionally controls the charging and discharging of the individual battery cells 104 to maintain an optimal operating temperature range within the battery pack 100. In other embodiments, the battery pack controller 128 disconnects battery cells 104 that exceed a predetermined maximum operating temperature and generates a visible or audible alarm if the temperature of the battery cells 104 exceeds the predetermined maximum operating temperature. In one embodiment, the electrochemical battery cells are connected to a relay or other switch that the controller 128 operates to disconnect the electrochemical cells from a charging source or a load if the temperature exceeds the maximum threshold. In some embodiments, the battery pack includes a plurality of switches that are connected to individual battery cells. The controller 128 is connected to each of the plurality of switches and only operates a subset of the switches to disconnect the corresponding electrochemical battery cells that exceed the predetermined maximum operating temperature threshold while the switches that are connected to the other electrochemical cells that remain below the temperature remain closed and the remaining electrochemical cells continue operation.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A temperature monitoring apparatus for a battery pack including at least one electrochemical cell comprising:
a printed circuit board mounted to the battery pack;
at least one infrared sensor supported by the printed circuit board, the at least one infrared sensor being positioned to view infrared radiation emitted from a surface of the at least one electrochemical cell in the battery pack without contacting the surface of the at least one electrochemical cell; and
a controller operatively connected to the at least one infrared sensor, the controller being configured to:
identify a temperature of the at least one electrochemical cell with reference to a temperature signal that is generated by the at least one infrared sensor.

2. The apparatus of claim 1 further comprising:
an alarm, the controller being operatively connected to the alarm and further configured to:
operate the alarm in response to identification of the temperature of the at least one electrochemical cell that exceeds a predetermined threshold.

3. The apparatus of claim 1 further comprising:
a switch connected to the at least one electrochemical cell; and
the controller being connected to the switch and further configured to:
operate the switch to disconnect the at least one electrochemical cell from one of a charging source and a load in response to identification of the temperature of the at least one electrochemical cell that exceeds a predetermined threshold.

4. The apparatus of claim 1 wherein the at least one electrochemical cell further comprises a plurality of electrochemical cells and the at least one infrared sensor further comprises a plurality of infrared sensors supported by the PCB, each infrared sensor in the plurality of infrared sensors being positioned to view infrared radiation emitted from a surface of one electrochemical cell in the plurality of electrochemical cells; and
the controller being operatively connected to each infrared sensor in the plurality of infrared sensors, the controller being further configured to:
identify a plurality of temperatures with reference to a plurality of temperature signals from the plurality of infrared sensors, each temperature in the plurality of temperatures corresponding to a temperature of a surface of one electrochemical cell in the plurality of electrochemical cells.

5. The apparatus of claim 4 further comprising:
an alarm, the controller being operatively connected to the alarm and further configured to:
operate the alarm in response to identification of at least one temperature in the plurality of temperatures that exceeds a predetermined threshold.

6. The apparatus of claim 4 further comprising:
a plurality of switches, each switch being connected to one electrochemical cell in the plurality of electrochemical cells; and
the controller being connected to the plurality of switches and further configured to:
operate one switch in the plurality of switches to disconnect one electrochemical cell in the plurality of electrochemical cells from one of a charging source and a load in response to identification of the temperature of the one electrochemical cell that exceeds a predetermined threshold.
